(19) United States
(12) Patent Application Publication
(10) Pub. No.: US 2026/0151719 A1
(43) Pub. Date: Jun. 4, 2026

(54) AIR INDUCTION UNIT FOR DUCT SEALING SYSTEM

(71) Applicant: Aeroseal LLC, Miamisburg, OH (US)

(72) Inventors: Ryder Grayson Combs, Dayton, OH (US); Suraj Kant Sahu, Dayton, OH (US); Zachay Andrew Reed, Dayton, OH (US)

(21) Appl. No.: 18/968,011

(22) Filed: Dec. 4, 2024

(51) Int. Cl. B01D 46/00; B01D 46/10; B01D 46/42

(52) U.S. Cl. CPC B01D 46/0047; B01D 46/0002; B01D 46/10; B01D 46/4263; B01D 2273/30

(57) ABSTRACT

An air induction unit for a duct sealing system includes a housing having a first wall defining an inlet opening and a second wall defining an outlet opening. A filter assembly is arranged inside the housing, dividing the housing into a first compartment and a second compartment, and includes a filter to filter the air. A fan assembly is arranged inside the second compartment and includes a casing having a first end arranged proximate to and offset from the filter assembly and defining an inlet port and a second end connected to the second wall defining an outlet port coaxially to the outlet opening. A fan is arranged inside the casing to draw air through an inlet opening and provide a pressurized air to the outlet opening. A shroud extends from the filter assembly to the first end of the casing and secured to the casing and the filter assembly.

### TECHNICAL FIELD

The disclosed subject matter relates generally to a duct sealing system for injecting sealant as aerosol inside a duct to seal any leakage. More particularly, the disclosed subject matter relates to an air induction unit of a duct sealing system and adapted to provide pressurized air to facilitate a formation of aerosol.

### BACKGROUND

Duct sealing equipment for injecting sealant in the form aerosol inside a duct to seal any leakage includes electronics components that are vulnerable to damage due to the sealant and humidity in the air reaching the electronic components during spray. The sealant may reach the electronic components as the sealant is injected inside duct, some of the sealant mixed with air is drawn inside a housing of the duct sealing system due to the suction created by a fan arranged inside the housing. This can cause the equipment to malfunction and rendering it unusable.

### SUMMARY

In accordance with one embodiment of the present disclosure, an air induction unit for a duct sealing system is disclosed. The air induction unit includes a housing having a first wall defining an inlet opening to facilitate an entry of air inside the housing and a second wall arranged opposite to the first wall and defining an outlet opening to facilitate an exit of air from the housing. The air induction unit also includes a filter assembly arranged inside the housing, dividing the housing into a first compartment extending from the first wall to the filter assembly and a second compartment extending from the filter assembly to the second wall. The filter assembly includes a filter to filter the air. Moreover, the air induction unit includes a fan assembly arranged inside the second compartment. The fan assembly includes a casing having a first end arranged proximate to and offset from the filter assembly and defining an inlet port and a second end connected to the second wall of the housing defining an outlet port arranged coaxially to the outlet opening. The fan assembly also includes a fan arranged inside the casing to create a suction to draw air from an ambient through an inlet opening and provide a pressurized air to the outlet opening. Furthermore, the air induction unit includes a shroud extending from the filter assembly to the first end of the casing and secured to the casing and the filter assembly. The air flows from the first compartment to the casing via the shroud after passing through the filter.

In some additional, alternative, or selectively cumulative embodiments, the filter assembly includes a filter frame connected to the housing and defining an opening. The filter is arranged covering the opening to enable a filtration of the air flowing to the fan from the first compartment through the opening.

In some additional, alternative, or selectively cumulative embodiments, the shroud includes a support structure attached to the filter frame and arranged surrounding the opening of the filter frame. The shroud also includes an engagement structure attached to the support structure. The casing is attached to the engagement structure.

In some additional, alternative, or selectively cumulative embodiments, the engagement structure includes a conduit portion extending from the support structure and a first flange arranged at an end of the conduit portion and extending radially outwardly from the conduit portion. The casing includes a second flange connected to the first flange.

In some additional, alternative, or selectively cumulative embodiments, the air induction unit comprises a clamp securely engaging the first flange with the second flange.

In some additional, alternative, or selectively cumulative embodiments, the clamp includes an arcuate shape having a U-shaped cross-section defining a groove. The first flange and the second flange are arranged inside the groove and a first circumferential end of the clamp is removably attached to a second circumferential end of the clamp to securely engage and retain the first flange and the second flange inside the groove.

In some additional, alternative, or selectively cumulative embodiments, the air induction unit further comprises an electric resistance heater mounted to the casing and arranged downstream of the fan to heat the pressurized air flowing to the outlet opening from the fan.

In accordance with another embodiment of the present disclosure, a duct sealing system for introducing a sealant inside a duct for sealing any leakage is provided. The duct sealing system includes an air induction unit to provide pressurized air to the duct. The air induction unit includes a housing having a first wall defining an inlet opening to facilitate an entry of air inside the housing and a second wall arranged opposite to the first wall and defining an outlet opening to facilitate an exit of air from the housing. The air induction unit also includes a filter assembly arranged inside the housing, dividing the housing into a first compartment extending from the first wall to the filter assembly and a second compartment extending from the filter assembly to the second wall. The filter assembly includes a filter for filtering the air flowing from the inlet opening to the outlet opening. The air induction unit further includes a fan assembly arranged inside the second compartment. The fan assembly includes a casing having a first end arranged proximate to and offset from the filter assembly and defining an inlet port and a second end connected to the second wall of the housing defining an outlet port arranged coaxially to the outlet opening. The fan assembly also includes a fan arranged inside the casing to create a suction to receive air from an ambient through an inlet opening and provide pressurized air to the outlet opening. Furthermore, the air induction unit includes a shroud extending from the filter assembly to the first end of the casing and secured to the casing and the filter assembly. Air flows from the first compartment to the casing via the shroud after passing through the filter. The duct sealing system also includes a sealant injection unit mounted to the housing and configured to inject sealant inside the duct at a location adjacent to the outlet opening to form a mixture of the sealant and pressurized air.

In some additional, alternative, or selectively cumulative embodiments, the filter assembly includes a filter frame connected to the housing and defining an opening. The filter is arranged covering the opening to enable a filtration of air flowing to the fan from the first compartment through the opening.

In some additional, alternative, or selectively cumulative embodiments, the shroud includes a support structure attached to the filter frame and arranged surrounding the opening, and an engagement structure attached to the support structure. The casing is attached to the engagement structure.

In some additional, alternative, or selectively cumulative embodiments, the engagement structure includes a conduit portion extending from the support structure and a first flange arranged at an end of the conduit portion and extending radially outwardly from the conduit portion. The casing includes a second flange connected to the first flange.

In some additional, alternative, or selectively cumulative embodiments, the air induction unit further comprises a clamp securely engaging the first flange with the second flange.

In some additional, alternative, or selectively cumulative embodiments, the clamp includes an arcuate shape having a U-shaped cross-section defining a groove. The first flange and the second flange are arranged inside the groove and a first circumferential end of the clamp is removably attached to a second circumferential end of the clamp to securely engage and retain the first flange and the second flange inside the groove.

In some additional, alternative, or selectively cumulative embodiments, the air induction unit further comprises an electric resistance heater mounted to the casing and arranged downstream of the fan to heat pressurized air flowing to the outlet opening from the fan.

### BRIEF DESCRIPTION OF THE DRAWINGS

Certain embodiments of the present disclosure will be better understood from the following description taken in conjunction with the accompanying drawings in which:

FIG. 1 illustrates a front perspective view of a duct sealing system having an air induction unit with a filter to filter the air being drawn inside a housing of the air induction unit, in accordance with one embodiment of the present disclosure;

FIG. 2 illustrates a rear perspective view of the duct sealing system depicting an outlet opening of the housing through which pressurized air exit the housing and a nozzle configured to inject or spray inside duct and to be mixed with the pressurized air to form the aerosol, in accordance with one embodiment of the present disclosure;

FIG. 3 illustrates a top perspective view of the duct sealing system with a roof of the housing removed and depicting an arrangement of various components of the air induction unit including a filter assembly, a fan assembly, and a shroud connecting the filter assembly to the fan assembly, in accordance with one embodiment of the present disclosure;

FIG. 4 illustrates a portion of the air induction unit depicting a clamp engaging the shroud and a casing of the fan assembly, in accordance with one embodiment of the present disclosure;

FIG. 5 illustrates a sectional view of a portion of the air induction unit along a section line A-A depicting a fan arranged inside the casing and a connection of the casing with the shroud via a clamp, in accordance with one embodiment of the present disclosure;

FIG. 6 illustrates a perspective view of the shroud and the fan assembly engaged with each other with the clamp removed, in accordance with one embodiment of the present disclosure; and

FIG. 7 illustrates a perspective view of the shroud of the air induction unit, in accordance with one embodiment of the present disclosure.

List of Elements: 100 duct sealing system, 102 air induction unit, 104 sealant injection unit, 106 reservoir, 110 nozzle, 120 housing, 122 base, 124 roof, 126 front wall, 128 rear wall, 130 sidewall, 132 sidewall, 134 chamber, 136 inlet opening, 138 outlet opening, 140 gate, 142 filter assembly, 144 first compartment, 146 second compartment, 148 filter frame, 150 filter, 152 first plate, 154 second plate, 156 cavity, 160 opening, 164 fan assembly, 166 casing, 168 first end, 170 second end, 172 inlet port, 174 fan, 176 outlet port, 178 tube portion, 180 heater, 182 shroud, 184 support structure, 186 first end, 188 second end, 190 body, 192 skirt portion, 194 edge, 196 base plate, 198 wall, 200 first opening, 204 second opening, 210 engagement structure, 212 conduit portion, 214 channel, 220 first flange, 222 second flange, 230 clamp, 231 groove, 232 first end, 234 second end, 236 first protrusion, 240 second protrusion, 242 second hole, 244 first wall, 246 second wall

### DETAILED DESCRIPTION OF EXEMPLARY EMBODIMENTS

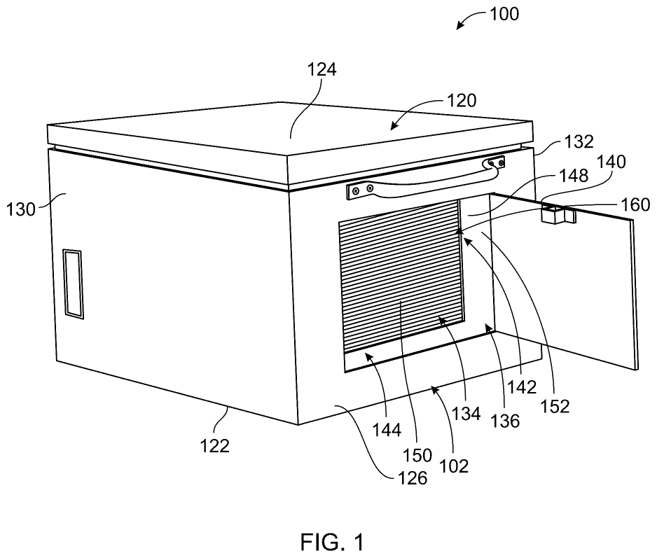

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-7, wherein like numbers indicate the same or corresponding elements throughout the views.

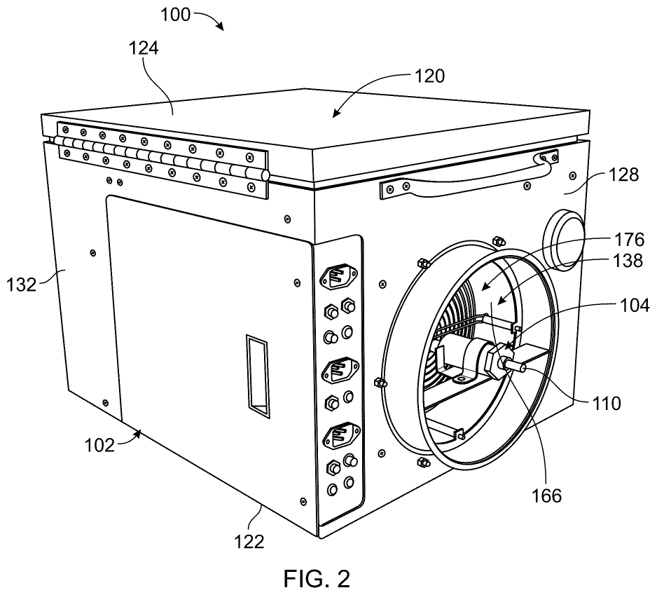

FIGS. 1 and 2 illustrates a front and rear perspective view of a duct sealing system, indicated generally at 100, in accordance with one embodiment of the present disclosure. The duct sealing system 100 includes an air induction unit 102 to pressurize air and induct pressurized air inside a duct and a sealant injection unit 104 to inject a sealant inside the duct to be mixed the pressurized air to form an aerosol that seals any leakage with the duct. For injecting the sealant, the sealant injection unit 104 includes a reservoir 106 to store the sealant, a nozzle 110 to atomize and inject the sealant inside the duct and mix with the pressurized air, a pump to supply the sealant to the nozzle 110 from the reservoir 106 at a desired pressure, and one more control units, for example, valves, sensors, and electronic circuitry that controls the flow of sealant to the nozzle 110 from the reservoir 106.

As shown, the air induction unit 102 includes a housing 120 adapted to house various components of the sealant injection unit 104 and the air induction unit 102 and acts as a frame for mounting various component of the duct sealing system 100. As shown in FIGS. 1 to 3, the housing 120 includes a base 122, an openable roof 124 arranged opposite to the base 122, a first wall 126, i.e., a front wall 126, a second wall, i.e., a rear wall 128 arranged opposite to the front wall 126, and a pair of sidewalls 130, 132 extending between the front wall 126 and the rear wall 128. The walls 126, 128, 130, 132 of the housing 120 extend in a vertical direction from the base 122 and supports the roof 124 of the housing 120. The base 122, the roof 124, and the walls 126, 128, 130, 132 together defines a chamber 134 in which various components of the system 100 are arranged. Moreover, to facilitate a flow of air inside the chamber 134 from an ambient environment, the front wall 126 defines an inlet opening 136, while rear wall 128 defines an outlet opening 138 to enable the exit of pressurized air from the housing 120. Further, a gate 140 is pivotally coupled to the front wall 126 to selectively open and close the inlet opening 136. As shown, the nozzle is arranged outwardly of the outlet opening 138 of the housing 120.

Further, the air induction unit 102 includes a filter assembly 142 arranged inside the chamber 134 and extending substantially parallel to the front wall 126 and the rear wall 128 and disposed proximate to the front wall 126 relative to the rear wall 128. The filter assembly 142 separates/divides the chamber 134 into a first compartment 144 extending from the front wall 126 to the filter assembly 142 and a second compartment 146 extending from the filter assembly 142 to the rear wall 128. The components of the sealant injection unit 104, for example, the reservoir 106, the pump, and other control components may be arranged inside the second compartment 146.

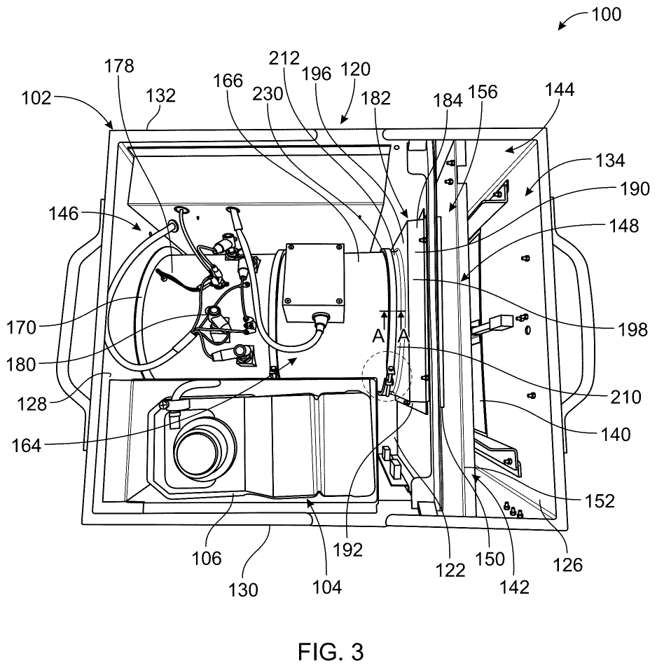

Referring to FIGS. 1 and 3, the filter assembly 142 includes a filter frame 148 mounted to side walls 130, 132 and the base 122, and a filter 150 attached to and supported on the filter frame 148. In the embodiment, the filter frame 148 has a pair of parallel plates, a first plate 152 and a second plate 154, arranged spaced apart from each other and defining a cavity 156 therebetween. Each of the plates 152, 154 are arranged substantially parallel to the front wall 126 and the rear wall 128, and includes a central opening 160. The filter 150 is arranged inside the cavity 156 and covering the openings 160 of the plates 152, 154. Accordingly, the filter is configured to filter 148 the air that exit the first compartment 144 through the openings 160. In the embodiment, the openings 160 are rectangular openings, however, it may be envisioned that openings 160 may include any suitable shape, for example, circular, elliptical, hexagonal, square, or any other shape known in the art.

Moreover, referring to FIGS. 3, 5, and 6, the air induction unit 102 includes a fan assembly 164 arranged inside the second compartment 146 to draw air inside the first compartment 146 through the inlet opening 136. The air flows to the fan assembly 164 from the first compartment 144 through the central openings 160 and the filter 150. As shown, the fan assembly 164 includes a casing 166 having a first end 168 arranged proximate to and offset from the filter assembly 142 i.e., filter frame 148 and a second end 170 connected to the rear wall 128 of the housing 120. As shown, the casing 166 defines an inlet port 172 at the first end 168 to enable a flow of air to a fan 174 arranged inside the casing 166. The fan 174 is arranged to draw air inside the casing 166 exiting the filter assembly 142 through the inlet opening and provide the pressurized air or high velocity air downstream of the fan 174. The pressurized air, then flows to an outlet port 176 of the casing 166 and exit the chamber 134 through the outlet opening 138 of the housing 120. In the illustrated embodiment, the outlet port 176 and the outlet opening 138 are coaxial to each other and includes identical size and shape.

To facilitate a flow of the air downstream of the fan 174, the casing includes a tube portion 178, shown in FIG. 3, extending from the fan 174 to the rear wall 128 and connected to the rear wall 128. It may be appreciated that an inner diameter of the tube portion 178 at the rear wall 128 is substantially equal to a diameter of the outlet opening 138. In an embodiment, the tube portion 178 and the casing 166 are integrally formed with each other. In some embodiments, the tube portion 178 and the casing 166 are attached to each other such that there is no air leakage through an interface of the tube portion 178 and the casing 166. Further, the air induction unit 102 includes a heater 180, shown in FIG. 3 mounted to the tube portion 178 i.e., the portion of the casing 166 arranged downstream of the fan 174 to heat the pressurized air flowing through the tube portion 178.

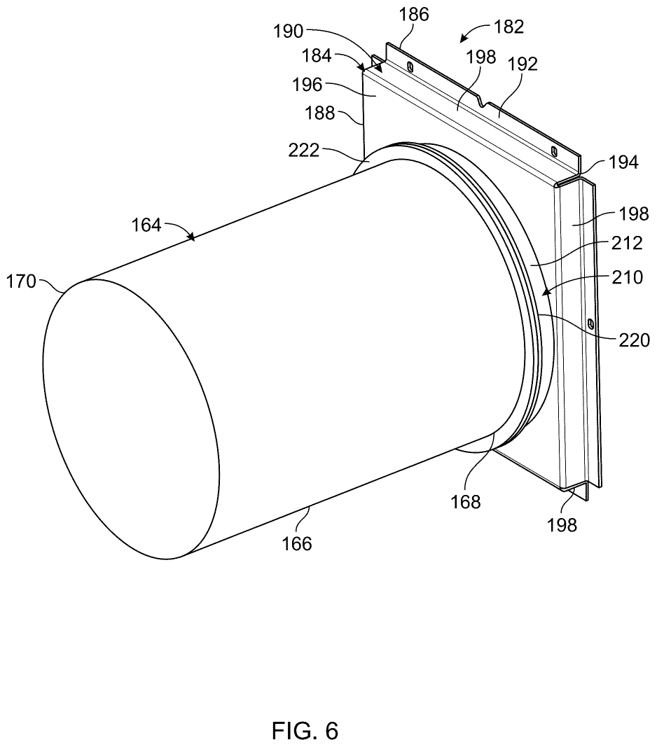

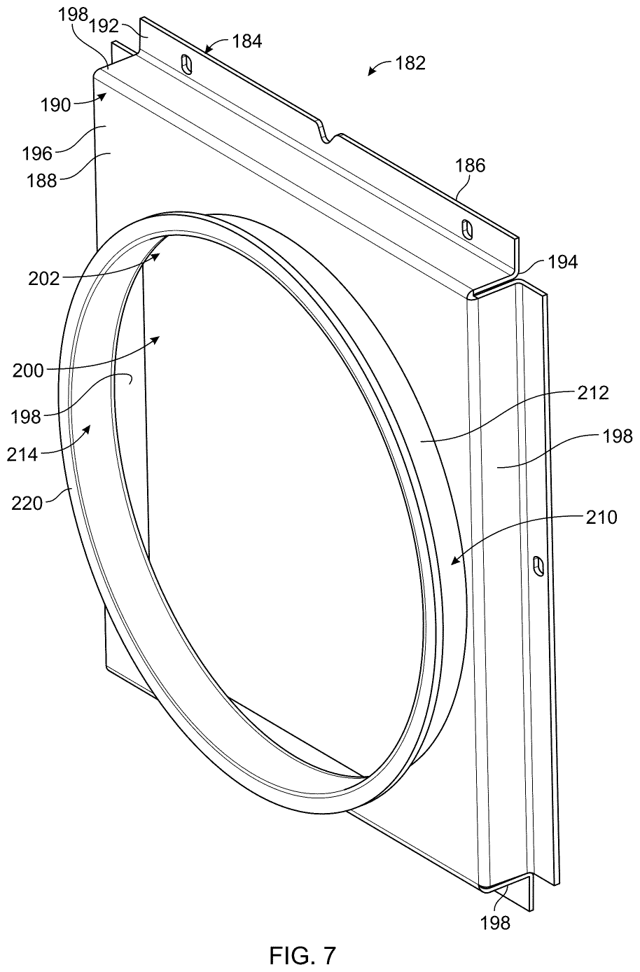

To direct a flow of air exiting the filter assembly 142 to the casing 166 i.e., the inlet port 172 of the casing 166, the air induction unit 102 includes a shroud 182, best shown in FIG. 6 and FIG. 7, arranged connected to the filter frame 148 and the casing 166 and extending between the casing 166 and the filter frame 182. Accordingly, the shroud 182 is arranged inside the second compartment 146 and connected to casing 166 and the filter assembly 142 i.e., filter frame 148 forming a leakproof connections therebetween. In the embodiment, the shroud 182 includes a support structure 184 having a first end 186 connected to the filter frame 148 and a second end 188 arranged distally from the filter frame 148. As shown, the support structure 184 includes a hollow body 190 and a skirt portion 192 extending substantially perpendicularly and outwardly from an edge 194 of the body 190. The skirt portion 192 is adapted to contact a surface of the filter frame 148 and is secured to the filter frame 148 via a plurality of fasteners. In the illustrated embodiment, the body 190 is a hollow cuboidal box having a substantially rectangular base plate 196 arranged substantially parallel to the plates 152, 154 of the filter frame 148 and arranged distally from the filter frame 148. As shown, the body 190 also includes a plurality of walls 198, four walls 198, extending from an outer edge of the base plate 196. Moreover, the skirt portion 192 is arranged substantially parallel to the base plate 196 and extends from the free edges of the walls 198. Accordingly, the free edges of the four walls 198 together define the edge 194 of the support structure 184. Further, the edge 194 define a first opening 200 of the support structure 184, while the base plate 196 defines a second opening 202 of the support structure 184. In the illustrated embodiment, the first opening 200 is a rectangular opening, while the second opening 202 is a circular opening. However, it may be appreciated that openings 200, 202 may include any other shape known in the art.

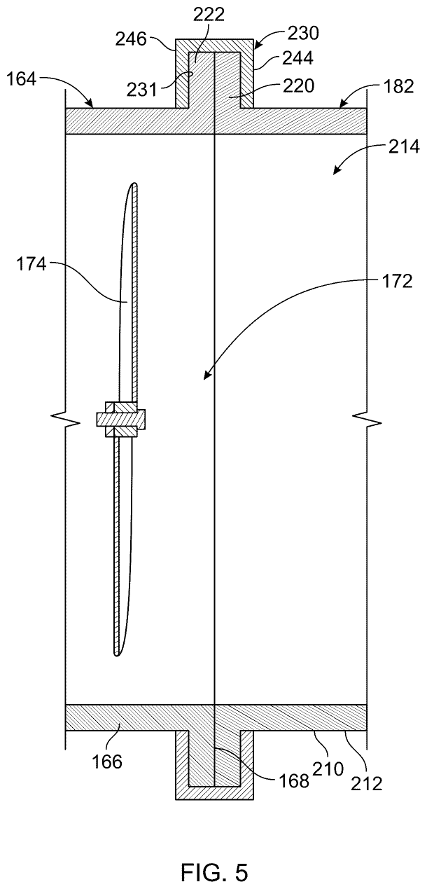

Further, the shroud 182 includes an engagement structure 210 adapted to be secured to the casing 166. In the illustrated embodiment, the engagement structure 210 includes a conduit portion 212 connected to the base plate 196 of the support structure 184 and extending in a longitudinal direction from the base plate 196 in a direction away from the filter frame 148. It may be appreciated that a diameter of the second opening 202 is smaller to or equal to an inner diameter of the conduit portion 212. The conduit portion 212 defines a channel 214, shown in FIG. 5, through which the air flows from the second opening 202 to the inlet port 172 of the casing 166. Moreover, the engagement structure 210 includes a flange 220, also referred to as a first flange 220, adapted to be engaged with a flange i.e., second flange 222, of the casing 166. The second flange 222 is arranged at the first end 168 of the casing 166. In some embodiments, the support structure 184 may be omitted, and in such a case, another flange is provided to connect the conduit portion 212 with the filter frame 148.

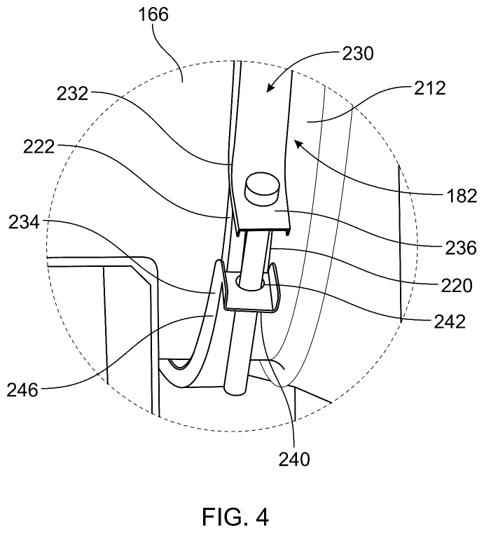

To secure the first flange 220 to the second flange 22, and to provide a leakproof connection between the casing 166 and the shroud 182, the air induction unit 102 includes a clamp 230, best shown in FIG. 4 and FIG. 5, having substantially U-shaped cross-section defining a groove 231 to receive the first flange 220 and the second flange 222. As shown, the clamp 230 includes an arcuate shape having a first circumferential end 232 and a second circumferential end 234 arranged spaced apart from the first end 232. The first end 232 is removably connected to the second end 234 to securely engage and retain the first flange 220 and the second flange 222 together. To facilitate the removable attachment of the first end 232 and the second 234, the clamp 230 includes a first protrusion 236 arranged at the first end 232 and defining a first hole (not shown) and a second protrusion 240 defining a second hole 242 and disposed at the second end 234. The first end 232 and the second end 234 are attached to each by extending a fastener through the aligned first hole and the second hole 242, and securing the first end 232 and the second end 234 using the fastener. It may be noted that the two ends 232, 234 are brought together as the fastener is tightened, removing any gap between the first flange 220 and the second flange 222, providing a leakproof joint.

As shown in FIG. 5, in the assembly of the clamp 230 with the first flange 220 and the second flange 222, a first wall 244 of the clamp 230 is arranged abutting the first flange 220, while a second wall 246, arranged facing the first wall 246, of the clamp 230 is arranged abutting the second flange 222. The fastener provides necessary force to hold the first flange 220 and the second flange 222 together in abutment with each other, providing a sealing contact therebetween, and therefore prevent any leakage of air from an interface of the first flange 220 and the second flange 222. In some embodiments, a sealing gasket may be disposed between the first flange 220 and the second flange 222. As the air flows the through the shroud 182 and the casing 166 to the outlet opening 176 from the filter assembly 142, the air is prevented from moving to the electronic components, arranged inside the second compartment 146, of the duct sealing system 100, minimizing the damage of the electronic components from the sealant and humidity laden air.

The foregoing description of embodiments and examples has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. An air induction unit for a duct sealing system, the air induction unit comprising:
a housing having a first wall defining an inlet opening to facilitate an entry of air inside the housing and a second wall arranged opposite to the first wall and defining an outlet opening to facilitate an exit of air from the housing;
a filter assembly arranged inside the housing, dividing the housing into a first compartment extending from the first wall to the filter assembly and a second compartment extending from the filter assembly to the second wall, the filter assembly includes a filter to filter the air;
a fan assembly arranged inside the second compartment and including
a casing having a first end arranged proximate to and offset from the filter assembly and defining an inlet port and a second end connected to the second wall of the housing defining an outlet port arranged coaxially to the outlet opening, and
a fan arranged inside the casing to create a suction to draw air from an ambient through an inlet opening and provide a pressurized air to the outlet opening; and
a shroud extending from the filter assembly to the first end of the casing and secured to the casing and the filter assembly, wherein air flows from the first compartment to the casing via the shroud after passing through the filter.

2. The air induction unit of claim 1, wherein the filter assembly includes a filter frame connected to the housing and defining an opening and the filter is arranged covering the opening to enable a filtration of air flowing to the fan from the first compartment through the opening.

3. The air induction unit of claim 2, wherein the shroud includes
a support structure attached to the filter frame and arranged surrounding the opening of the filter frame, and
an engagement structure attached to the support structure, wherein the casing is attached to the engagement structure.

4. The air induction unit of claim 3, wherein
the engagement structure includes a conduit portion extending from the support structure and a first flange arranged at an end of the conduit portion and extending radially outwardly from the conduit portion, and
the casing includes a second flange connected to the first flange.

5. The air induction unit of claim 4 further comprises a clamp securely engaging the first flange with the second flange.

6. The air induction unit of claim 5, wherein the clamp includes an arcuate shape having a U-shaped cross-section defining a groove, wherein the first flange and the second flange are arranged inside the groove and a first circumferential end of the clamp is removably attached to a second circumferential end of the clamp to securely engage and retain the first flange and the second flange inside the groove.

7. The air induction unit of claim 1 further comprises an electric resistance heater mounted to the casing and arranged downstream of the fan to heat the pressurized air flowing to the outlet opening from the fan.

8. A duct sealing system for introducing a sealant inside a duct for sealing any leakage, the duct sealing system comprising:
an air induction unit to provide pressurized air to the duct, the air induction unit comprises
a housing having a first wall defining an inlet opening to facilitate an entry of air inside the housing and a second wall arranged opposite to the first wall and defining an outlet opening to facilitate an exit of air from the housing,
a filter assembly arranged inside the housing, dividing the housing into a first compartment extending from the first wall to the filter assembly and a second compartment extending from the filter assembly to the second wall, the filter assembly includes a filter to filter air flowing from the inlet opening to the outlet opening,
a fan assembly arranged inside the second compartment and including
a casing having a first end arranged proximate to and offset from the filter assembly and defining an inlet port and a second end connected to the second wall of the housing defining an outlet port arranged coaxially to the outlet opening, and
a fan arranged inside the casing to create a suction to receive air from an ambient through an inlet opening and provide a pressurized air to the outlet opening, and
a shroud extending from the filter assembly to the first end of the casing and secured to the casing and the filter assembly, wherein air flows from the first compartment to the casing via the shroud after passing through the filter; and
a sealant injection unit mounted to the housing and configured to inject sealant inside the duct at a location adjacent to the outlet opening to form a mixture of the sealant and pressurized air.

9. The duct sealing system of claim 8, wherein the filter assembly includes a filter frame connected to the housing and defining an opening and the filter is arranged covering the opening to enable a filtration of air flowing to the fan from the first compartment through the opening.

10. The duct sealing system of claim 9, wherein the shroud includes
a support structure attached to the filter frame and arranged surrounding the opening, and
an engagement structure attached to the support structure, wherein the shroud is attached to the engagement structure.

11. The duct sealing system of claim 10, wherein
the engagement structure includes a conduit portion extending from the support structure and a first flange arranged at an end of the conduit portion and extending radially outwardly from the conduit portion, and
the casing includes a second flange connected to the first flange.

12. The duct sealing system of claim 11, wherein the air induction unit further comprises a clamp securely engaging the first flange with the second flange.

13. The duct sealing system of claim 12, wherein the clamp includes an arcuate shape having a U-shaped cross-section defining a groove, wherein the first flange and the second flange are arranged inside the groove and a first circumferential end of the clamp is removably attached to a second circumferential end of the clamp to securely engage and retain the first flange and the second flange inside the groove.

14. The duct sealing system of claim 8, wherein the air induction unit further comprises an electric resistance heater mounted to the casing and arranged downstream of the fan to heat pressurized air flowing to the outlet opening from the fan.
